(19) United States
(12) Patent Application Publication
(10) Pub. No.: US 2010/0165017 A1
(43) Pub. Date: Jul. 1, 2010

(54) CONTINUOUS INKJET PRINTERS

(76) Inventors: Andrew Robert Lester, Cambridgeshire (GB); Anthony Davidson-Smith, Bedfordshire (GB)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/447,365

(22) PCT Filed: Oct. 26, 2007
(86) PCT No.: PCT/GB2007/004098

§ 371 Date: Jan. 19, 2010

(30) Foreign Application Priority Data
Oct. 27, 2006 (GB) 0621374.8

(51) Int. Cl. B41J 29/38

(52) U.S. Cl. 347/5

(57) ABSTRACT

The invention provides a power-up/shut-down facility for a continuous inkjet printer which enables the printer to be readied for printing and returned to standby by operation of a single control.

### FIELD OF THE INVENTION

This invention relates to continuous inkjet (CIJ) printers used for industrial and/or commercial marking and coding.

### BACKGROUND TO THE INVENTION

Industrial marking and coding equipment is a well-known art. Articles carried on a moving line are displaced past a station at which a mark is applied thereto. One means of applying the mark is a CIJ printer.

For a typical CIJ printer, a power-on switch is displaced to boot-up the machine. Once booted-up, the machine operator typically accesses a menu on a user interface and selects an option to cause the machine to undergo a start-up sequence. This start-up sequence may, for example, involve cleaning the print head and establishing a stable jet. Before shut-down the operator again needs to access the control menu, select and operate a shut-down cycle, wait for the completion of that cycle, before displacing a power-off switch.

Both start-up and shut-down operations require on-going operator presence and participation and this can be wasteful of time and resource.

It is an object of this invention to provide a method and/or apparatus which will go at least some way in addressing the aforementioned problems; or which will at least offer a novel and useful alternative.

### SUMMARY OF THE INVENTION

Accordingly, in one aspect, the invention provides marking and/or coding apparatus having a power on facility and a start-up cycle facility, said apparatus being characterized in that both said power-on facility and said start-up cycle facility are able to be initiated by operation of a single control.

Preferably said apparatus includes a main printer processor and a sub-processor, said sub-processor being operable to determine the initiation of said start-up cycle facility and to maintain said start-up facility until said apparatus is under the control of said main printer processor.

Preferably the apparatus is further characterised in that a manually operated control is included, the operation of which causes the apparatus to undergo a close-down cycle and then place the apparatus in standby.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

An embodiment of the invention will now be described with reference to the accompanying drawings in which:

FIG. 1: shows an example of a user interface for a printer embodying the invention;

FIG. 2: shows a circuit for performing an automatic start-up/shut-down according to the invention

FIG. 3: shows an example of printer operating software activity when the printer is start-up from standby;

FIG. 4: shows an example of printer operating software activity when one control is operated to change the printer state from “ready to print” to “booted-up”; and

FIG. 5: shows an example of printer operating software activity when the printer is shut-down to a standby state.

### DESCRIPTION OF WORKING EMBODIMENT

This invention provides a method and apparatus for controlling the start-up of a continuous inkjet (CIJ) printer. Adoption of the invention allows the start-up process, comprising power-up and the adoption of a start-up cycle, to be a one step process as opposed to the lengthy two-step system which currently applies. In its preferred embodiment, the invention also allows a one-step shut down cycle and power off.

As used herein the following definitions shall apply:
Standby: A state in which mains power is applied to the printer but the operating components of the printer are not powered up.
Powered-up: The printer power supply unit (PSU) is enabled to supply relevant dc supplies to the printer components.
Booted-up: The printer is powered up and, in addition, all system components are enabled and running ready to accept operating commands via user/external interfaces. In this state the printer is not ready to print data.
Sequenced-on: The printer is booted up, taken through a start-up cycle to clean the printhead and establish a stable jet, and is ready to print data.

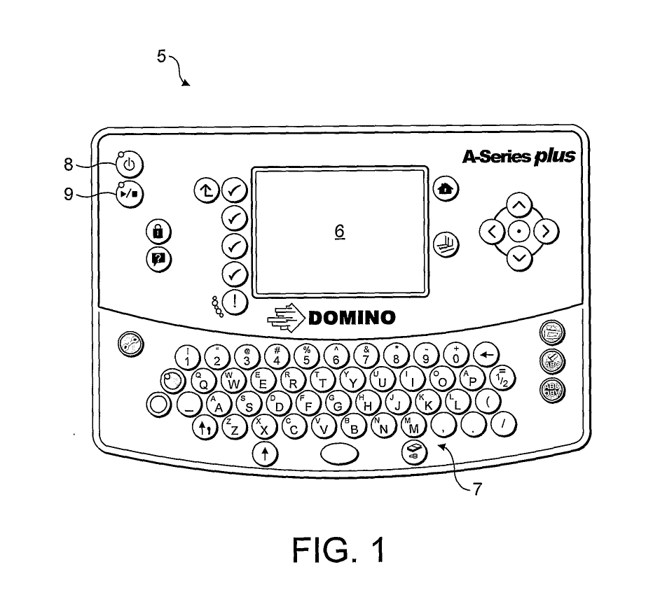

Referring firstly to FIG. 1, a CIJ printer embodying the invention will have a user interface or operating panel 5 which, in the form shown, includes a display 6 on which data relating to the printer is displayed. A keyboard 7 may also be provided to allow data to be loaded in to the printer by an operator. On the upper left hand edge of the panel is a power on/off switch 8 (also referred to below as SW1) and, beneath that, a start sequence switch 9 (also referred to below as SW2). As will be apparent from the description which follows, operation of either switch will bring the printer power supply unit out of stand-by and cause the printer to boot-up. However, if switch 9 is operated, the machine will also take itself through a start-up cycle and ready itself for printing.

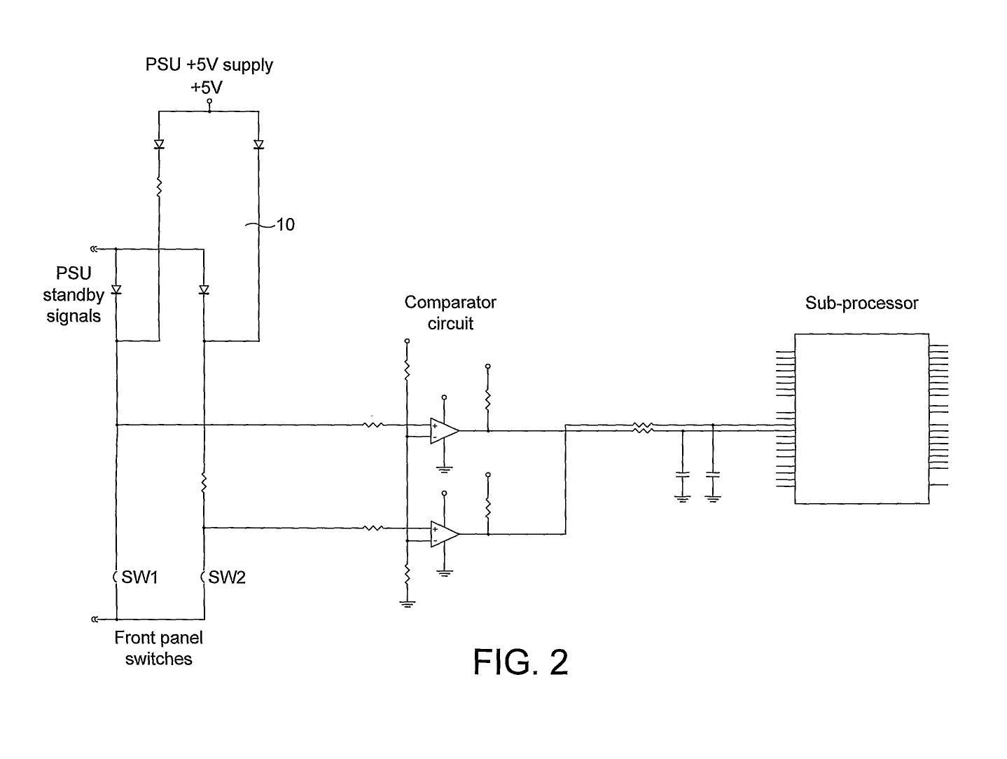

Referring now to FIG. 2 a printer to which the invention is applied is arranged to be in standby for so long as it is connected to a mains power supply. The mains power supply, at all times, supplies power supply unit (PSU). The PSU may brought out of standby through the action of a remote power-on/power off circuit 10. The operation of power-on switch SW1 or power-on/sequence-on switch SW2 causes the PSU to become enabled if previously in standby mode. Further, the PSU can be returned to standby mode from enabled mode through the action of circuit 10 but only by operation of switch SW1.

Whilst the form of the sequence-on cycle is not part of the invention, it typically includes a jet-cleaning step followed by the establishment of a stable jet of the ink to be printed.

Being in parallel and covering a single switch signal, detecting which of switches SW1 and SW2 is operated would not normally be possible. However, in accordance with the embodiment of apparatus herein described, the switched pins of both of switches SW1 and SW2 are connected to a comparator circuit which determines the switch positions and provides this data to a sub-processor. This sub-processor is, in effect, subordinate to the main printer operating processor (not shown). The position of that switch which has been operated is latched in this sub-processor which causes the selected printer function to be carried out until the main printer operating processor boots-up and takes over. In this way, the start-cycle can be initiated while the machine boots-up and without requiring further operator intervention.

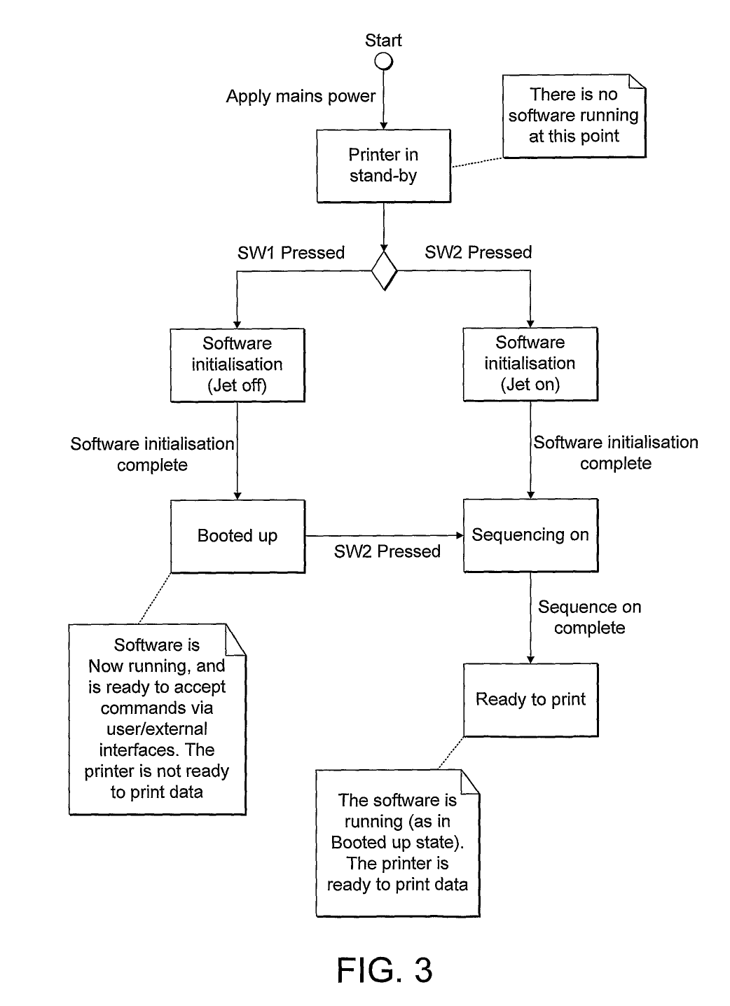

Referring now to FIG. 3, the optional start-up routes are shown. As can be seen, with the print in standby, the depression of switch SW1 causes initialisation of the system software but does not, otherwise, prepare the printer for printing. On the other hand, depression of switch SW2 not only initialises the system software but also initiates the sequencing cycle and places the printer in a state ready to commence printing. If the printer is booted-up but has not undergone the start-up cycle, depression of switch SW2 will initiate the sequencing-on step. The printer is then ready to start printing.

At the end of printing, the apparatus as herein described can also be powered-down in a single step. Whereas prior art printers require an operator to select a shut-down cycle (jet dis-establishment, jet and gutter cleaning) followed by a power-off command, the apparatus described herein, by simple operation of one of switches SW1 or SW2, can either return the printer to booted-up mode, or to standby mode.

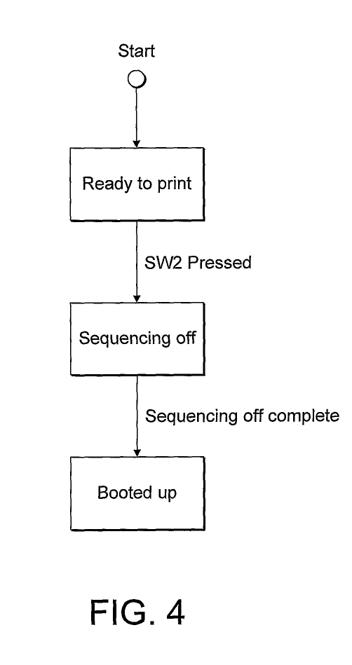

Referring now to FIG. 4, with the printer in a state ready to print, depression of switch SW2 causes the printer to undergo a sequencing-off cycle and then leave the printer booted-up but not ready to print. The printer can be returned to a state in which it is ready to print by again depressing switch SW2, thus initiating a further sequencing-on step.

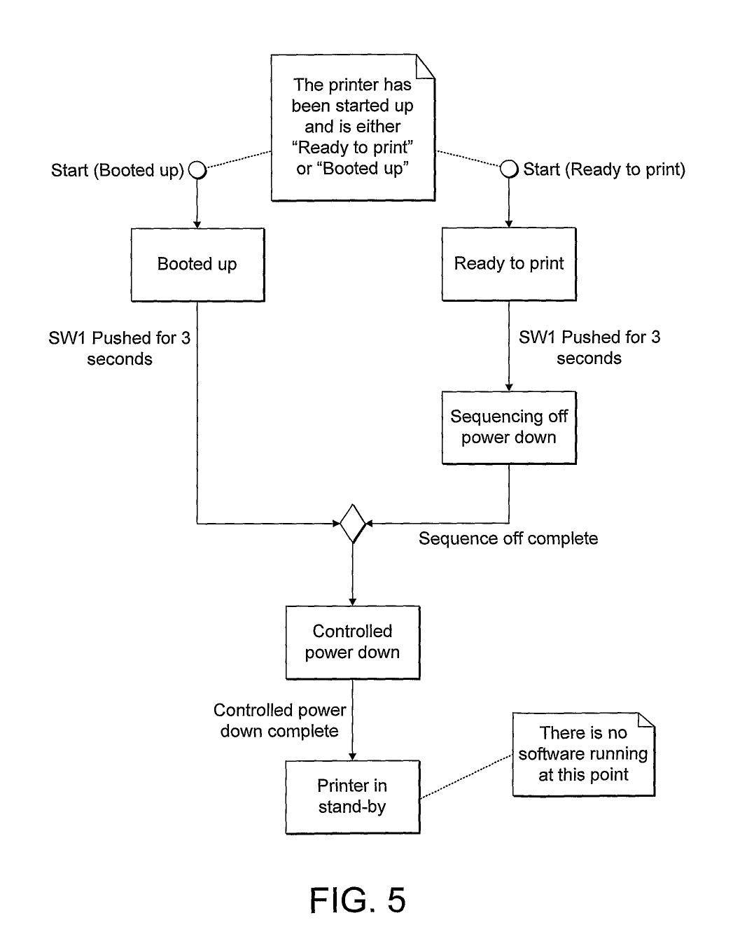

If, whilst the printer is in a state ready to print, or is booted-up; and it is desired to return the printer to standby, switch SW1 is depressed. The functional steps which follow are shown in FIG. 5. If, following the end of a printing operation, the printer has already been placed in the booted-up state by operation of switch SW2, switch SW1 may then be depressed to initiate a controlled power-down step which ends with the printer being placed in standby mode. If the printer is still fully functional and switch SW1 is depressed, the system software first instructs the printer to undergo a sequencing-off or shut-down cycle, before controlling power down to standby.

It will thus be appreciated that the present invention, at least in the case of the embodiment herein described, provides a simple one-step start/stop operation which requires minimal operator intervention both in terms of time and skill.

1. A marking and/or coding apparatus having a power-on facility and a start-up cycle facility, said apparatus being characterized in that both said power-on facility and said start-up cycle facility are able to be initiated by operation of a single control.

2. The apparatus as claimed in claim 1 including a main printer processor and a sub-processor, said sub-processor being operable to determine the initiation of said start-up cycle facility and to maintain said start-up facility until said apparatus is under the control of said main printer processor.

3. The apparatus as claimed in claim 2 further characterized in that a manually operated control is included, the operation of which causes the apparatus to undergo a close-down cycle and then place the apparatus in stand-by.

4. The apparatus as claimed in claim 3 wherein said manually operated control comprises said single control.

5. The apparatus as claimed in claim 1 further characterized in that a manually operated control is included, the operation of which causes the apparatus to undergo a close-down cycle and then place the apparatus in stand-by.

6. The apparatus as claimed in claim 5 wherein said manually operated control comprises said single control.
